(19) United States
(12) Patent Application Publication
(10) Pub. No.: US 2004/0172459 A1
(43) Pub. Date: Sep. 2, 2004

(54) Multi-tier business layer architecture for information systems

(76) Inventors: Brian E. Schwalm, Superior, CO (US); Jeffrey S. Neafsey, Arvada, CO (US)

Correspondence Address: Merchant & Gould P.C., P.O. Box 2903, Minneapolis, MN, 55402-0903, US

(21) Appl. No.: 10/376,953

(22) Filed: Feb. 27, 2003

(51) Int. Cl. G06F 15/16

(52) U.S. Cl. 709/217

(57) ABSTRACT

An architectural software model for managing data retrieval in an information system is disclosed. The architectural software model includes a presentation layer, a business layer and a data layer. The business layer serves as a communication liaison between the presentation layer, which requires data to perform various electronic tasks in the information system, and the data layer, which storing the data required by the presentation layer. As such, the business layer receives requests from presentation layer components for specified data stored in the data layer, and in response to these requests, manages retrieval of the specified data. The business layer is divided into multiple portions, with each portion sharing responsibilities of the business layer. In simplest form, the business layer has a first portion and a second portion. The first portion is responsible for receiving requests from components of the presentation layer and providing views of the requested data to these requesting components. The second portion is responsible for communicating with the data layer to access and thereafter cache in a local data structure the data specified in each request.

### TECHNICAL FIELD

The invention relates generally to information systems, and more particularly, to a multi-tier business layer architecture for managing data within information systems.

### BACKGROUND OF THE INVENTION

Typical information systems include at least one computing system for use in performing tasks in electronic fashion. The computing system performs many of these tasks by, among other things, manipulating data which had been previously stored on a storage medium of the system. Illustrating this case, a requesting module of the computing system first sends a request to a data managing module for information required for performance of a task. Upon receipt of the request, the data managing module manages the retrieval of the requested information from the storage medium. The data managing module then prepares and sends the retrieved information to the requesting module, which thereafter manipulates the information in furtherance of performing the task.

In many implementations, an information system is defined as a collection of computing systems communicatively connected to one another by a common network. At least one computing system in the information system is referred to as a server, whereas the other computing systems are referred to as clients. Because an abundance of common information is typically required by multiple, if not all, clients in these multi-computer information systems, it is often useful to delegate the storage of data to a central database, thereby reserving client resources for local tasks and data. The server serves as, or alternatively is attached by a communications link to, this central database. Each client sends requests for data stored in the central database to the server, which thereafter manages the retrieval of the requested data. Once retrieved, the server prepares and sends the data to the client.

Regardless of whether an information system is implemented as a single computer or multi-computer environment, system designers often design the flow of information between storage and the requestor using a model that logically governs information retrieval based on a three-tier architecture. Conventional architectural models are constructed with portions of programming logic referred to as layers. Typical architectural models include a presentation layer, a business layer and a data layer. The presentation layer is responsible for manipulating data to perform a specified task, such as, for example, rendering a display for output to a display monitor. The data layer stores the data required for manipulation by the presentation layer. The business layer, in general, manages retrieval of the required data from the data layer. As such, the business layer is considered to reside “between” the presentation layer and the data layer. Requesting modules and clients typically take the physical form of the presentation layer. Data storage media and databases typically take the physical form of the data layer. Data managing modules and server computers typically take the physical form of the business layer. However, the model is considered a “logical” model in that a system component may physically take the form of different layers in different implementations of an information system. For example, a client may take the physical form of the presentation layer in one implementation, while taking the physical form of the presentation layer and the business layer in another implementation.

The use of a three-tiered architectural model to implement prior art information system ensures that the presentation layer, already responsible for data manipulation, is not also responsible for data retrieval. As such, the processing overhead associated with data retrieval does not tie up resources needed to manipulate data in furtherance of the performance of tasks by the presentation layer. However, this conventional three-tiered architectural model is not without shortfalls. For each request issued by a component of the presentation layer, the business layer retrieves an instance of data from the data layer and caches this instance prior to replying to the request with the data. If another component of the presentation layer requests the same data, this retrieval and caching process is repeated and the data is locally duplicated with a second instance being cached within the business layer. Obviously, with the possibility of numerous components requesting the exact same data, the processes used by conventional three-tiered architectural models to manage retrieval of data results in a significant waste of system resources. Furthermore, if data is updated or modified while one or more instances of the data are cached in the business layer, the component(s) for which the data has been retrieved and cached are provided old data, the manipulation of which is most likely no longer useful to the associated task(s).

### SUMMARY OF THE INVENTION

In accordance with the present invention, the above and other problems are solved by an architectural model having a multi-tier business layer for managing the retrieval of data within an information system. The multi-tier business layer serves as a communication liaison between a presentation layer requiring data to perform various electronic tasks in the information system and a data layer storing the required data. As such, the multi-tier business layer receives requests from presentation layer components for specified data stored in the data layer, and in response to these requests, manages retrieval of the specified data.

In an embodiment, the multi-tier business layer is divided into multiple portions, or software modules. The portions operate together to manage retrieval of data requested by components of the presentation layer. A first portion of the multi-tier business layer is responsible for receiving requests for specified data issued by components of the presentation layer as well as subsequently providing a view of the requested data to the requesting components. The view presents the specified data to the requesting component through an object created for each request. Also, there is only a single instance of the data, and multiple “views” or “references” to that single instance.

A second portion of the multi-tier business layer is responsible for communicating with the data layer to access data specified in each request. In response to such access, the second portion receives an instance of the specified data from the data layer and subsequently caches the data instance to a data structure local to the multi-tier business layer. In an embodiment, cached data is organized in the data structure based on the standard identifier. Each object existing in the first portion creates a view of the data instance of which each object is associated by the standard identifier. Each requesting component for which an object is created views the data through object associated with that request.

While cached in the local data structure, data instances are available for substantially immediate presentation to a requesting component of the presentation layer, thereby enabling the second portion to respond to the first portion by establishing a view of specified data from the local cache. As such, the data does not have to be retrieved from the data layer each subsequent time that a request for the same data is made. In order to help alleviate the possibility of providing outdated cached data to a requesting component, an embodiment of the present invention provides an exhaustion procedure whereby data cached in the local data structure is refreshed after an allocated expiration period predetermined for each data type.

In another embodiment, the second portion of the multi-tier business layer may be divided into a first sub-portion and a second sub-portion. In this embodiment, the first sub-portion is responsible for receiving requests for specified data from the first portion and, in response, providing the data to the first portion. Depending on whether the specified data is already cached in the local data structure, the first sub-portion may also communicate with the data layer to access data specified in each request. The second sub-portion is responsible for receiving instances of specified data from the data layer in response to requests from the first sub-portion as well as subsequently caching received data instances to the local data structure. In this embodiment, either the first or second sub-portions may implement the exhaustion procedure of the present invention.

In yet another embodiment, certain data types of which an instance is received by the second portion from the data layer may not be cached to the local data structure, but rather provided directly to the first portion. These certain types of data include, without limitation, secure and/or sensitive data as well as data that is very frequently or spontaneously updated. In this embodiment, an object created for a request for these certain data types may either store instances of these certain data types as part of the object, or alternatively, forward the instances directly to the presentation layer. If an instance of these data types are stored as part of a created object, the object presents the data to the requesting component using a view stored as part of the object. The object, and thus the instance of data, is deleted as the requesting component expires, which typically occurs as the underlying application program is shut down.

In accordance with various embodiments, the present invention is implemented as a computer process, a computing system or as an article of manufacture, such as, without limitation, a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process.

These and various other features as well as advantages, which characterize the present invention, will be apparent from a reading of the following detailed description and a review of the associated drawings.

### BRIEF DESCRIPTION OF THE DRAWINGS

FIG. 1 illustrates a logical architectural model for implementing an information system in accordance with an embodiment of the present invention, including a presentation layer, a business layer and a data layer, wherein the business layer is divided into a business object portion and a data interface portion.

FIG. 2 is an embodiment of the logical architectural model of FIG. 1, wherein the data interface portion of the business layer is divided into a data client sub-portion and a data store sub-portion in accordance with a particular embodiment of the present invention.

FIG. 3 is a physical representation of the information system of FIG. 1 showing an embodiment of the logical architectural model used to implement the information system in accordance with an embodiment of the present invention.

FIG. 4 is the physical representation of FIG. 3 showing the embodiment of the logical architectural model used to implement the information system in accordance with another embodiment of the present invention.

FIG. 5 depicts a block diagram of a suitable computing environment in which an embodiment of the present invention may be implemented.

FIG. 6 is a flow diagram that illustrates operational characteristics performed by the business object portion of the business layer of FIG. 1 in accordance with an embodiment of the present invention.

FIG. 7 is a flow diagram that illustrates operational characteristics performed by the data interface portion of the business layer of FIG. 1 in accordance with an embodiment of the present invention.

FIG. 8 is a flow diagram that illustrates operational characteristics performed by the data store sub-portion of the data interface portion of FIG. 2 in accordance with an embodiment of the present invention.

### DETAILED DESCRIPTION

The present invention and its various embodiments are described in detail below with reference to the figures. When referring to the figures, like structures and elements shown throughout are indicated with like reference numerals.

The present invention relates to management of data retrieval within an information system. Embodiments of the present invention may be implemented in a single computer environment or a multi-computer, i.e., client-server, environment. As such, the information system includes at least one computing system having one or more application programs, wherein software modules of the application program manipulate data to perform tasks in electronic fashion. The data is stored on storage media, which, in a single computer information system reside on the computer and in a multi-computer information system reside in a central database.

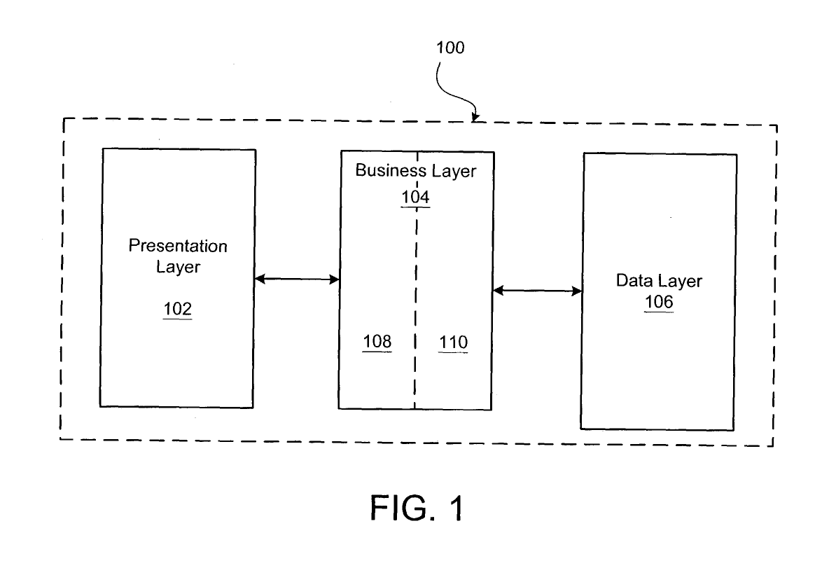

Referring to FIG. 1, a conceptual illustration of a three-tier architectural model 100 for managing data retrieval within an information system is shown in accordance with an embodiment of the present invention. The three-tier architectural model 100 includes a presentation layer 102, a business layer 104 and a data layer 106. Each of these layers (102, 104 and 106) of the architectural model 100 are software modules designed to interact with one another to provide a logical framework for managing retrieval of stored data for various other software modules in the information system. As with any computing system, logical operations of the present invention interact with hardware modules to implement processes of the information system. As such, even though not explicitly stated when illustrating the present invention, any of the computer-implemented operations performed by these layers (102, 104 and 106) may also include interaction with one or more hardware modules in the information system.

Generally described, the presentation layer 102 is responsible for manipulating data for the performance of a task. Such a task may include, for example, rendering the data for display on a graphical user interface (GUI). The data layer 106 stores the data that is to be manipulated by the presentation layer 102.

The business layer 104 is an “intermediate” layer that serves as a communication liaison between the presentation layer 102 and the data layer 106. That is, the presentation layer 102 issues requests for retrieval of specified data stored in the data layer 106 to the business layer 104 rather than communicating directly with the data layer 106. In response to such a request, the business layer 104 is then responsible for retrieving the specified data from the data layer 106 and providing a view of the retrieved data to the presentation layer 102. The view presents the specified data to the presentation layer 102 in a manner such that the presentation layer 102 may manipulate the data to perform a specific task. For example, the presentation layer 102 may display data presented through a view on a display element of a graphical user interface. Prior to retrieving the specified data, the business layer 104 applies one or more business rules to the request in furtherance of managing retrieval of the data for the presentation layer 102. As described in more detail below, these business rules relate to conditions that are designed to effectuate the transfer of data between the data layer 106 and the presentation layer 102.

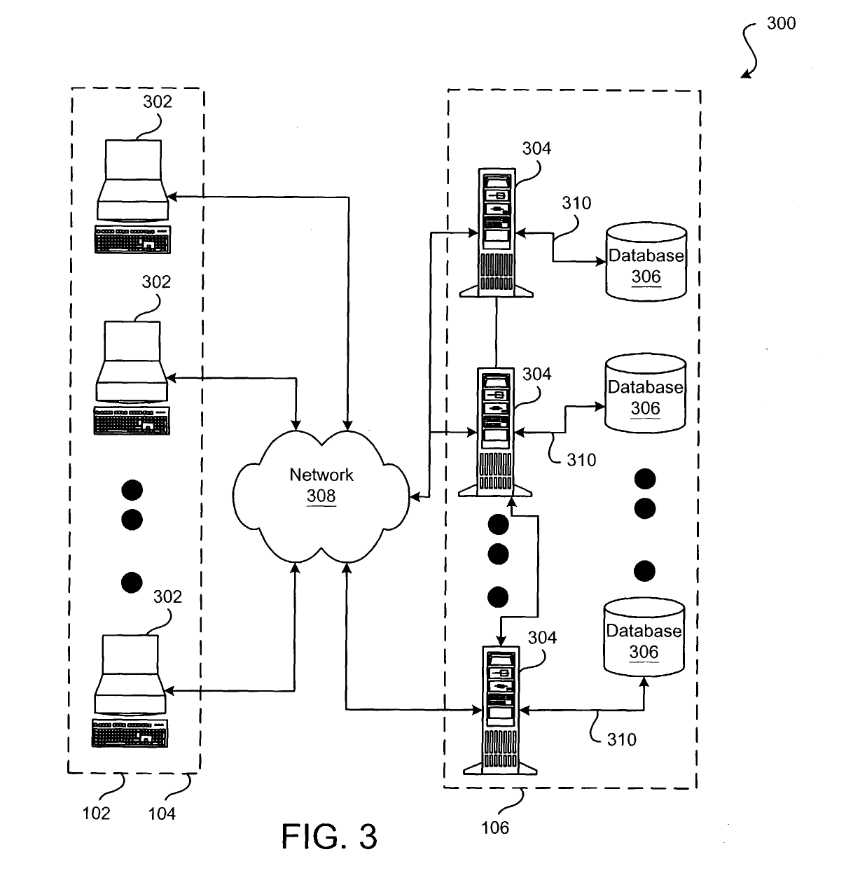

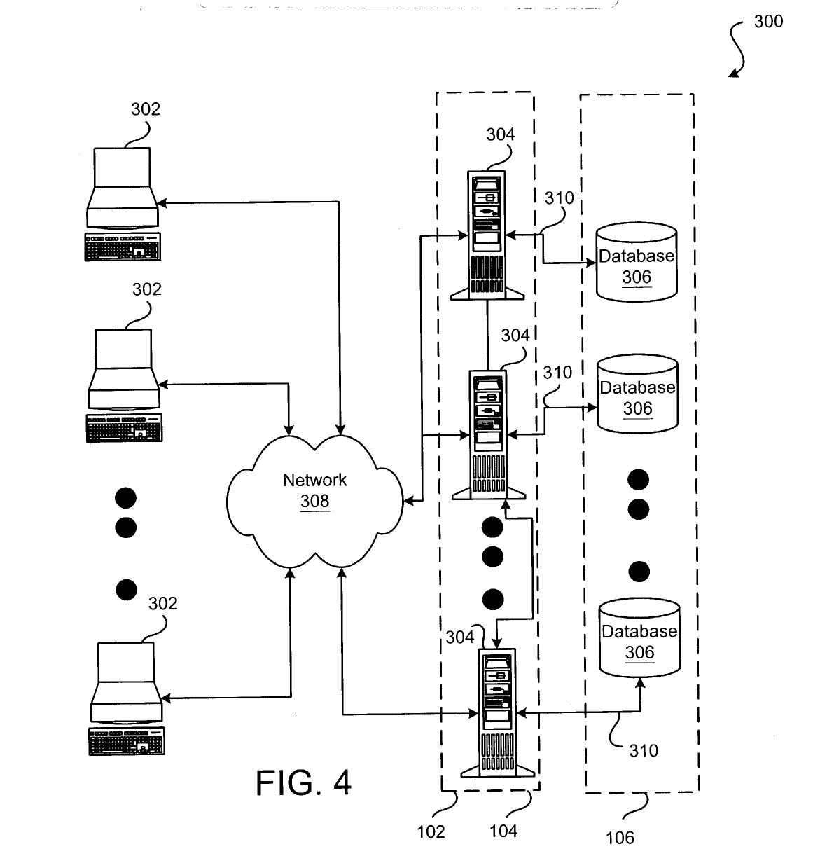

In an embodiment, each of these layers (102, 104 and 106) resides on a single computing system. In another embodiment, at least one of these layers (102, 104 and 106) resides on a computing system separate from the other two layers (102, 104 and 106). For example, the presentation layer 102 may reside on a client computer system and the middle-tier layer 104 and the data layer 106 may both reside on a server computer system. Even further, each layer (102, 104 and 106) may reside on a separate computing system from the other. In either of these latter embodiments, a communications network is employed for communications between the layers (102, 104 and 106) residing on separate computer systems, as shown and described in more detail in FIGS. 3 and 4. It should be appreciated that each of the layers (102, 104 and 106) operate as described below in FIGS. 1-8 regardless of whether the layers (102, 104 and 106) reside on a single computing system or multiple computing systems.

The presentation layer 102 includes software modules and processes (collectively, “components”) of application programs that use data stored in the data layer 106 to perform tasks, such as, without limitation, rendering information for display on a GUI presented to users through a display monitor. It should be appreciated that these tasks may relate to any form of data manipulation or processing, and therefore are not limited to rendering data for display on a GUI. Indeed, many components of application programs manipulate data during “background” operations that are not noticeable to users of the computing system. These types of tasks may be performed either randomly or following scheduled, periodic time periods. For illustrative purposes, however, the presentation layer 102 is described as a component requesting data from the data layer 106 for use in manipulating the data to render a display for a GUI.

In an embodiment, data is stored in the data layer 106 in the form of file structures, each having a standard identifier, e.g., path and file name, recognizable to the business layer 104 and data layer 106. In order to request specific data stored in the data layer 106, a request by a component of the presentation layer 102 includes, i.e., specifies, the standard identifier for the data. Upon receiving a request from the component, the business layer 104 manages retrieval of the specified data from the data layer 106 based on the standard identifier and thereafter provides a view of the retrieved data to the requesting component. The view presents the specified data to the presentation layer in a manner such that the data may be manipulated to perform a specific task.

It should be appreciated that means for organizing data in the data layer 106 other than standard identifiers are contemplated within the scope of the present invention. As such, it should also be appreciated that methods other than recognition of standard identifiers may be used to locate data stored in the data layer 106. The implementation for organizing and the use of such organization to retrieve specified data is therefore a matter of choice, and the methods described herein are rather provided as an illustration of an exemplary embodiment of the present invention.

In accordance with the present invention, the responsibilities and/or operations of the business layer 104 are performed by various software modules into which the business layer 104 is divided. These software modules are referred to herein as “portions” of the business layer 104. The layout of these portions within the business layer 104 is referred to herein as a “pattern.” The business layer 104 is partitioned into a business object portion 108 and a data interface portion 110 in accordance with an embodiment of the present invention. The business object portion 108 is responsible for receiving requests from components of the presentation layer 102 for data stored in the data layer 106 and providing the requesting components with a view of the specified data. The data interface portion 110 is the portion of the business layer 104 responsible for the actual retrieval, and subsequent caching, of the specified data.

Upon receiving a request for data from a component of the presentation layer 102, the business object portion 108 creates a business object for the request. The business object serves as the communication liaison for that request and is responsible for establishing a view of the specified data for the component after the data has been retrieved from the data layer 106. In an embodiment, a business object is created for each request received by the business object portion 108. In an alternative embodiment, however, a business object may be associated with the requesting component, rather than each request, and thus, multiple requests from a component may communicate with a single business object.

After the business object portion 108 has created a business object for a received request, the business object passes the standard identifier of the requested data to the data interface portion 110 of the business layer 104. In an embodiment, the data interface portion 110 analyzes the standard identifier against at least one of a set of business rules prior to accessing the data layer 106. Each business rule relates a condition to the request, and more specifically, to the data specified in the request, as identified by a standard identifier. Examples of business rules include, without limitation, whether the requested data is already cached in a data structure local to the business layer 104, and if so, whether this data has been cached for a period in time longer than its allocated expiration time period. The business rules may also relate the identification of the database in the data layer 106 that stores the specified data as well as what type of network the data interface portion 110 is to connect to in order to access the identified database if the requested data is not already cached in local data structure or if the previously cached data has expired. The specific business rules that are to be used by the data interface portion 110 to manage retrieval of data in an information system are a matter of choice. In an embodiment, business rules are predefined by one or more software programmers that have designed all or part of the hardware or software infrastructure of the information system.

In accordance with an embodiment of the present invention, at least one of the business rules applied by the data interface portion 110 relates to whether an instance of the specified data has already been retrieved from the data layer 106 and cached by the data interface portion 110 pursuant to a previous request. If so, the data interface portion 110 does not access the data layer 106, but rather returns a view of the previously cached data instance to the business object. If, on the other hand, the specified data had not been previously retrieved from the data layer 106 and cached in the data interface portion 110, the data interface portion 110 accesses the data layer 106 to retrieve the specified data.

To accomplish data retrieval, the data interface portion 110 first sends the standard identifier of the requested data to the data layer 106. The data layer 106 then references the requested data based on the standard identifier and extracts an instance of the data, which the data layer 106 then transmits back to the data interface portion 110. In an embodiment, the data layer 106 includes sufficient business logic operable to perform this functionality. In an alternative embodiment, the data interface portion 110 or a third portion (not shown) of the business layer 104 may include this business logic rather than the data layer 106. Regardless of which layer (104 or 106) includes this required business logic, the functionality remains substantially the same.

The data interface portion 110 timestamps the instance of data with a time relative to when the instance of data is received by the data interface portion 110. The data interface portion 110 then caches the instance of data to a local data structure, where the instance maintains association with the standard identifier for future reference. In an embodiment, the local data structure is a table or group of tables having columns and rows, with at least one column of each row including the standard identifier for each instance of data contained in another column of the same row. To complete the retrieval of data for the requesting component of the presentation layer 102, the data interface portion 110 creates a view of the instance of data in the local data structure and subsequently forwards this view of the appropriate business object. Upon receiving the view, the business object provides the view of the requesting component such that the component is provided the data in a manner suitable for manipulation.

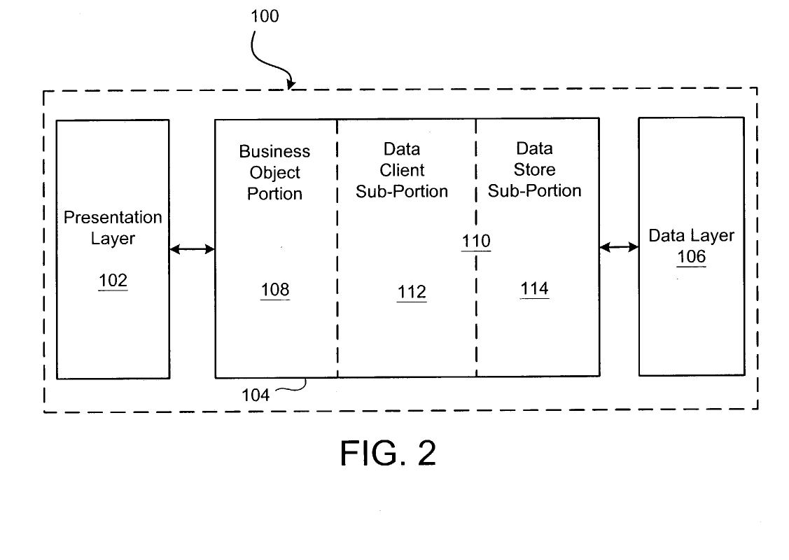

Referring now to FIG. 2, the architectural model 100 of FIG. 1 is shown in accordance with another embodiment of the present invention. In this embodiment, the business layer 104 is partitioned into the business object portion 108 and the data interface portion 110 as with the embodiment depicted in FIG. 1. However, the data interface portion 110 is partitioned into a data client sub-portion 112 and a data store sub-portion 114, with each of these sub-portions (112 and 114) dividing the responsibilities described above for the data interface portion 110.

The data store sub-portion 114 manages the caching of data received from the data layer 106. As such, the data store sub-portion 114 represents the logical operations performed on the local data structure. The data client sub-portion 112 serves as the communication liaison between the business object portion 108 and the data layer 106, and thus the data store sub-portion 114. Standard identifiers specified in requests issued to the business object portion 108 by a component of the presentation layer 102 are passed from the created business object to the data client sub-portion 112. The data client sub-portion 112 applies one or more business rules to the standard identifier. The business rules applied to the standard identifier by the data client sub-portion 112 are a sub-set of the rules described above with respect to the data interface portion 110 of FIG. 1.

In accordance with an embodiment of the present invention, at least one rule applied by the data client sub-portion 112 relates to whether an instance of the specified data has already been retrieved from the data layer 106 and cached by the data store sub-portion 114 to the local data structure pursuant to a previous request. There exist various methods in which the data client sub-portion 112 can make this determination. In an embodiment, the data client sub-portion 112 maintains a list of standard identifiers for all data instances retrieved from the data layer 106. In another embodiment, the data client sub-portion 112 may establish a communication session with the data store sub-portion 114, wherein the data client sub-portion 112 sends the standard identifier to the data store sub-portion 114, which runs an inquiry against each standard identifier included within the local data structure.

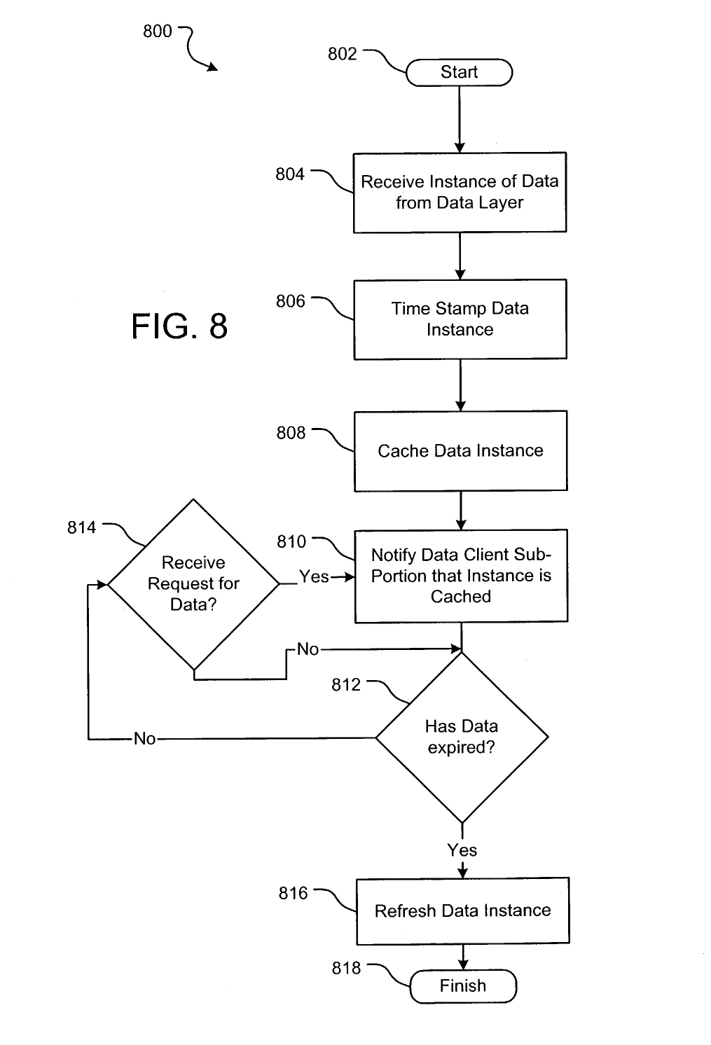

If the specified data is already cached in the local data structure, the data client sub-portion 112 requests a view of the cached instance from the data store sub-portion 114. In response to this request, the data store sub-portion 114 first accesses the local data structure to create a view of the cached instance and then sends the view of the data client sub-portion 112. In accordance with another embodiment, the data client sub-portion 112 accesses the local data structure to create the view of the cached instance, thereby eliminating the step of the data store sub-portion 114 having to send the view of the data client sub-portion 112. In this embodiment, the data store sub-portion 114 notifies the data client sub-portion 112 that the data instance is indeed cached in the local data structure, and thus available to view, as shown and described with reference to FIG. 8. In either embodiment, the end result is the data client sub-portion 112 receiving or creating the view of the cached instance and subsequently forwarding the view of the appropriate business object.

If the specified data has not been previously retrieved from the data layer 106 and cached by the data store sub-portion 114 to the local data structure, the data client sub-portion 112 accesses the data layer 106 to retrieve the specified data. To accomplish data retrieval, the data client sub-portion 112 first sends the standard identifier of the requested data to the data layer 106. The data layer 106 then references the requested data based on the standard identifier and extracts an instance of the data, which the data layer 106 then transmits to the data store sub-portion 114. As such, the data layer 106 includes sufficient business logic operable to perform this extraction process. In accordance with alternative embodiments, either the data store sub-portion 114 or a third portion (not shown) of the business layer 104 may actually perform the extraction process. In these embodiments, the data store sub-portion 114 or the third portion include sufficient business logic operable to perform the above-noted extraction process.

Upon receiving the instance of data, the data store sub-portion 114 time stamps the instance with a time reference relative to when the instance is received and caches the instance to the local data structure in a manner such that the instance maintains association with its standard identifier. As such, data instances are organized in the local data structure based on a common identification standard, which in this embodiment, is the standard identifiers used by each layer (102, 104 and 106) in the information system. In an alternative embodiment, the common identification standard may be a type of identification used internal to the business layer 104. In this alternative embodiment, data instances are labeled with this internal identification as the instances are cached by the data store sub-portion 114.

In accordance with an embodiment of FIG. 2, the data client sub-portion 112 applies an expiration business rule to each cached data instance in response to receiving a request for that data and determining that the data is cached to the local data structure. If an instance of data has been cached for longer than a predetermined period in time, as determined based on the expiration business rule, the data client sub-portion 112 refreshes that instance by requesting a new instance of the data from the data layer 106. Upon receipt of the new instance, the data store sub-portion 114 replaces the expired instance with the new instance. This new instance is then time-stamped and cached by the data store sub-portion 114 for any subsequent requests forwarded to the data client sub-portion 112 by the business object portion 108. After the new instance is cached, the data client sub-portion 112 creates a view of the data instance and subsequently passes the view of the appropriate business object.

In accordance with another embodiment of FIG. 2, the data store sub-portion 114 continuously applies an expiration business rule to all data instances cached in the local data structure. If an instance of data has been cached for longer than a predetermined period in time, as determined based on the expiration business rule, the data store sub-portion 114 refreshes that instance by requesting a new instance of the data from the data layer 106. Upon receipt of the new instance, the data store sub-portion 114 replaces the expired instance with the new instance. This new instance is then time-stamped and cached by the data store sub-portion 114 for any subsequent requests forwarded to the data client sub-portion 112 by the business object portion 108. As such, any updates or modifications performed on the data are reflected in the instance cached by the data store sub-portion 114 such that the requesting component is therefore provided current data without the data client sub-portion 112 having to make another request to the data layer 106.

The length of the predetermined period in time varies between the different types of data stored in the data layer 106. For example, data representing an address of a contact for use in a contact manager application program may have a shorter expiration time than data representing the contact's name due to the fact that addresses are randomly modified whereas an individual's name rarely changes. Thus, an exemplary predetermined time period for an address data type may be one day where an exemplary predetermined time period for a name data type may be one year.

Referring now to FIGS. 3 and 4, a physical representation of an information system 300 implementing alternative embodiments of the architectural model 100 for managing retrieval of stored data in the information system 300 is shown in accordance with an embodiment of the present invention. The information system 300 includes a plurality of client computers 302 communicatively connected to a plurality of server computers 304 over a communication network 308. In an embodiment, each of the plurality of server computers 304 is communicatively connected to a database 306 by way of a direct communication link 310. In another embodiment, each of the plurality of server computers 304 may be communicatively connected to a database 306 by way of the communication network 308. In yet another embodiment, each of the server computers 304 may include an internal database 306.

It should be appreciated that the communication network 308 may be any type of network known to those skilled in the art or an equivalence thereto. Some exemplary networks include, without limitation, the Internet, an Intranet, a private line network, or even a direct communication link. It should also be understood that the communication network 308 may utilize any number of communication technologies depending on functions required by the embodiment. Examples of specific technologies used in the communication network 308 contemplated include, without limitation, terrestrial, cellular, satellite, short-wave, and microwave connections to the Internet, directly between facilities using modems or other interface devices, or through other communications networks, such as local area networks or wide area networks. Any combination of these or other communications networks may be utilized and remain within the scope of the invention.

With particular interest to the present invention, the information system 300 shown in FIGS. 3 and 4 utilizes the three-tier architectural model 100 to manage retrieval of stored data within the information system 300. As such, logical operations related to data retrieval are implemented using embodiments of the presentation layer 102, the business layer 104 and the data layer 106 described with reference to FIGS. 1 and 2. Although both embodiments illustrated in FIG. 3 and FIG. 4 utilize the three-tier architectural model 100, these embodiment are considered “alternative” embodiments because implementation of the various layers (102, 104 and 106) of the architectural model 100 resides on alternative physical components, as described in the following paragraph.

In the embodiment of FIG. 3, the client computers 302 implement the presentation layer 102 and the business layer 104. In this embodiment, the client computers 302 are considered “thick” clients due to the extensive amount of intelligence associated with both the presentation layer 102 and the business layer 104 operating thereon. The server computers 304 and the attached databases 306 together implement the data layer 106.

Contrasting the embodiment of FIG. 3 with the embodiment of FIG. 4, the client computers 302 in the embodiment of FIG. 4 do not implement a single layer (102, 104 and 106) of the architectural model 100. Rather, the client computers 302 have limited intelligence, and are therefore referred to as “thin” clients. An example of a thin client is a web browser that displays HTML pages generated by web servers. In the embodiment of FIG. 4, the presentation layer 102 and the business layer 104 are implemented on the server computers 304. The databases 306 implement the data layer 106.

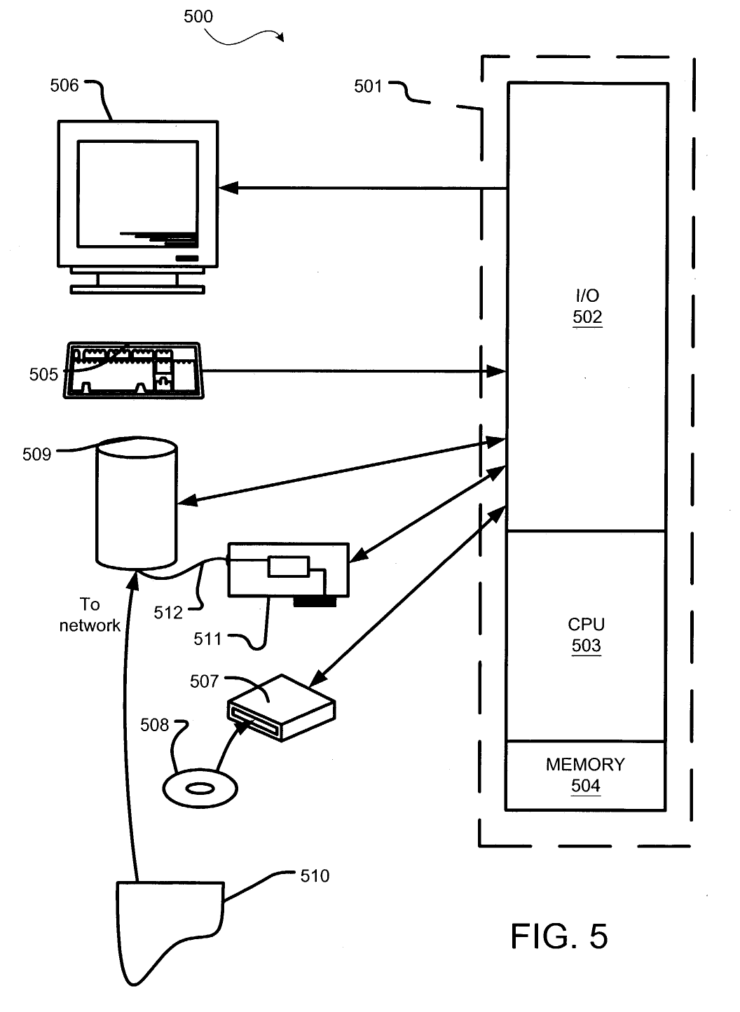

FIG. 5 depicts a general-purpose computing system 500 capable of executing a program product embodiment of the present invention. One operating environment in which the present invention is potentially useful encompasses the general-purpose computing system 500. In such a system, data and program files may be input to the computing system 500, which reads the files and executes the programs therein. Some of the elements of a general-purpose computing system 500 are shown in FIG. 5 wherein a processor 501 is shown having an input/output (I/O) section 502, a Central Processing Unit (CPU) 503, and a memory section 504. The present invention is optionally implemented in software devices loaded in memory 504 and/or stored on a configured CD-ROM 508 or storage unit 509 thereby transforming the computing system 500 to a special purpose machine for implementing the present invention.

The I/O section 502 is connected to a keyboard 505, a display unit 506, a disk storage unit 509, and a disk drive unit 507. In accordance with one embodiment, the disk drive unit 507 is a CD-ROM driver unit capable of reading the CD-ROM medium 508, which typically contains programs 510 and data. Computer program products containing mechanisms to effectuate the systems and methods in accordance with the present invention may reside in the memory section 504, the disk storage unit 509, or the CD-ROM medium 508 of such a system. In accordance with an alternative embodiment, the disk drive unit 507 may be replaced or supplemented by a floppy drive unit, a tape drive unit, or other storage medium drive unit. A network adapter 511 is capable of connecting the computing system 500 to a network of remote computers via a network link 512. Examples of such systems include SPARC systems offered by Sun Microsystems, Inc., personal computers offered by IBM Corporation and by other manufacturers of IBM-compatible personal computers, and other systems running a UNIX-based or other operating system. A remote computer may be a desktop computer, a server, a router, a network PC (personal computer), a peer device or other common network node, and typically includes many or all of the elements described above relative to the computing system 500. Logical connections may include a local area network (LAN) or a wide area network (WAN). Such networking environments are commonplace in offices, enterprise-wide computer networks, intranets, and the Internet.

In accordance with a program product embodiment of the present invention, software instructions, such as instructions directed toward communicating data between a client and a server, detecting product usage data, analyzing data, and generating reports, may be executed by the CPU 503; and data, such as products usage data, corporate data, and supplemental data generated from product usage data or input from other sources, may be stored in memory section 504, or on the disk storage unit 509, the disk drive unit 507 or other storage medium units coupled to the system 500.

As is familiar to those skilled in the art, the computing system 500 further comprises an operating system and usually one or more application programs. The operating system comprises a set of programs that control operations of the computing system 500 and allocation of resources. The set of programs, inclusive of certain utility programs, also provide a graphical user interface to the user. An application program is software that runs on top of the operating system software and uses computer resources made available through the operating system to perform application specific tasks desired by the user. In accordance with an embodiment, the operating system may employ a graphical user interface wherein the display output of an application program is presented in a rectangular area on the screen of the display device 506. The operating system is operable to multitask, i.e., execute computing tasks in multiple threads, and thus may be any of the following: Microsoft Corporation's “WINDOWS 95,” “WINDOWS CE,” “WINDOWS 98,” “WINDOWS 2000,” “WINDOWS NT” or “WINDOWS XP” operating systems, IBM's OS/2 WARP, Apple's MACINTOSH SYSTEM 8 operating system, X-windows, LINUX, etc.

In accordance with the practices of persons skilled in the art of computer programming, the present invention is described below with reference to acts and symbolic representations of operations that are performed by the computing system 500, a separate storage controller or a separate tape drive (not shown), unless indicated otherwise. Such acts and operations are sometimes referred to as being computer-executed. It will be appreciated that the acts and symbolically represented operations include the manipulations by the CPU 503 of electrical signals representing data bits causing a transformation or reduction of the electrical signal representation, and the maintenance of data bits at memory locations in the memory 504, the configured CD-ROM 508 or the storage unit 509 to thereby reconfigure or otherwise alter the operation of the computing system 500, as well as other processing signals. The memory locations where data bits are maintained are physical locations that have particular electrical, magnetic, or optical properties corresponding to the data bits.

The logical operations of the various embodiments of the present invention are implemented (1) as a sequence of computer-implemented steps running on a computing system 500 and/or (2) as interconnected machine modules within the computing system 500. The implementation is a matter of choice dependent on the performance requirements of the computing system 500 implementing the invention. Accordingly, the logical operations making up the embodiments of the present invention described herein are referred to alternatively as operations, acts, steps or modules. It will be recognized by one skilled in the art that these operations, structural devices, acts and modules may be implemented in software, in firmware, in special purpose digital logic, and any combination thereof without deviating from the spirit and scope of the present invention as recited within the claims attached hereto.

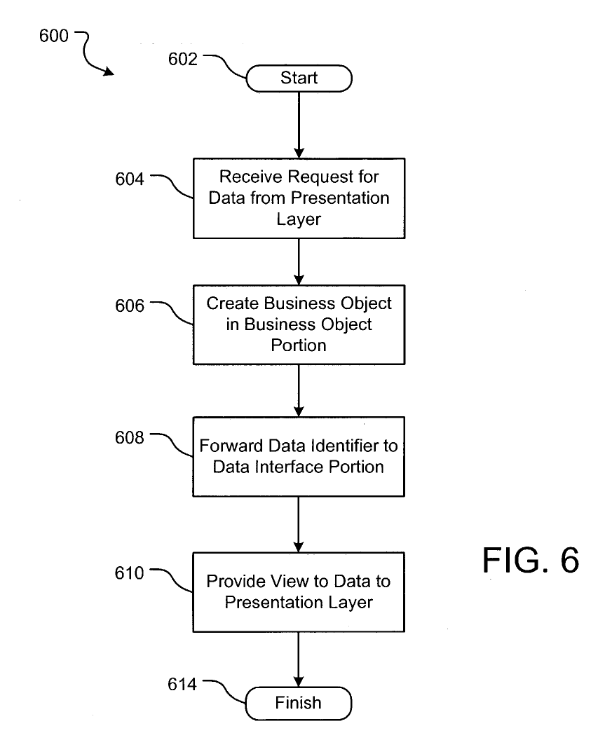

Referring now to FIG. 6, a process 600 generally illustrating operations associated with the retrieval of stored data by the business layer 104 is shown in accordance with an embodiment of the present invention. More specifically, the process 600 is a sequence of operations performed by the business object portion 108 of the business layer 104 in response to receiving a request for specified data from the presentation layer 102. With the embodiment of FIG. 1 in mind, the process 600 is performed using a flow of operations beginning with a start operation 602 and concluding with a terminate operation 614.

The start operation 602 is initiated as a component of the presentation layer 102 issues a request to the business layer 104 specifying data that the component requires for performance of a task. In an embodiment, the data that is to be retrieved by the business layer 104 is identified in the request using a standard identifier. From the start operation 602, the operation flow passes to a request receive operation 604. The request receive operation 604 receives the request and parses out the standard identifier. From the request receive operation 604, the operation flow passes to a create operation 606. The create operation 606 creates a business object for the request. The business object is an object created to serve as the communication liaison between the data interface portion 110 of the business layer 104 and the requesting component. The business object stores the standard identifier as a pointer, or reference, to the specified data. From the create operation 606, the operation flow passes to a forward operation 608.

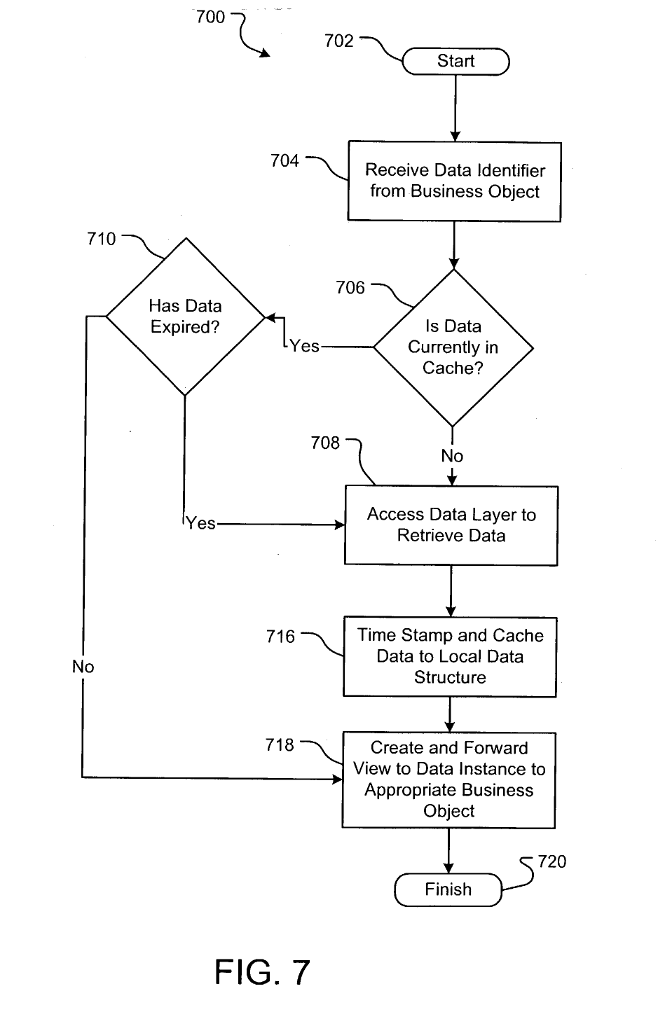

The forward operation 608 forwards the standard identifier to the data interface portion 110 of the business layer 104. As described in more detail with respect to FIG. 7, the data interface portion 110 manages retrieval of the data specified by the standard identifier as well as caching the data to a local data structure. The cached data is organized in the local data structure based on the standard identifier associated with the data in accordance with an embodiment of the invention. For example, the local data structure may store all data retrieved by the data interface portion 110 in a table having multiple rows for each instance of data stored, wherein each row includes at least one column for the standard identifiers and one column for the actual data. In an alternative embodiment, the data interface portion 110 may organize the data in the local data structure based on an identification scheme other than the standard identifier. After the instance of data has been cached to the local data structure, the data interface portion 110 creates a view of the data instance and passes the view of the business object. Upon receipt of the view by the business object, the operation flow passes to a present operation 610.

The present operation 610 provides the view of the cached data instance to the component of the presentation layer 102 that initiated the request. Multiple business objects in the business object portion 108 may reference the same instance of data cached to the local data structure. As such, there may exist multiple views to the same data. In accordance with this embodiment, a copy of the retrieved data is not cached with the business object, but rather only the standard identifier is maintained with the business object. As such, the only copy of the retrieved data saved on the business layer 104 is the instance cached to the local data structure by the data interface portion 110. From the present operation 610, the operation flow concludes at the terminate operation 614.

Referring now to FIG. 7, a process 700 generally illustrating operations associated with the retrieval of data by the business layer 104 is shown in accordance with another embodiment of the present invention. More specifically, the process 700 is a sequence of operations performed by the data interface portion 110 of the business layer 104 in response to receiving a standard identifier from the business object portion 108. With the embodiment of FIG. 1 in mind, the process 700 is a flow of operations beginning with a start operation 702 and concluding with a terminate operation 720.

The start operation 702 is initiated as a business object created by the business object portion 108 transmits a standard identifier to the data interface portion 110. As such, the start operation 702 is initiated following performance of the forward operation 608 of the process 600 shown in FIG. 6. From the start operation 702, the operation flow passes to a receive operation 704. The receive operation 704 receives the standard identifier transmitted by business object. From the receive operation 704, the operation flow passes to a first query operation 706.

The first query operation 706 determines whether an instance of the data specified by the received standard identifier is currently cached in the local data structure. To make such a determination, the first query operation 706 compares the standard identifier to each of the standard identifiers stored in the local data structure. In an embodiment, a list of each standard identifier stored in the local data structure is compiled by the data interface portion 110 as data instances are cached to the data structure. In this embodiment, the first query operation 706 examines this list to determine whether a standard identifier in the list matches the received standard identifier.

If the first query operation 706 determines that an instance of the data specified by the received standard identifier is not currently cached in the local data structure, the operation flow passes to an access data operation 708. The access data operation 708 establishes a communication session with the data layer 106 wherein the data interface portion 110 requests an instance of the specified data by passing the standard identifier to the data layer 104. The data layer 104 then uses the standard identifier to locate and extract an instance of the specified data. The instance of the specified data is then transmitted by the data layer 104 to the data interface portion 110. Following the access operation 708, the operation flow passes to a data receive operation 716.

The data receive operation 716 receives the data instance transmitted to the data interface portion 110 by the data layer 106. Upon receipt of the data instance, the data receive operation 716 time stamps the instance with a time reference relative to a point in time when the instance is received. The time reference is used by the second query operation 710, described below, to determine whether a data instance cached in the local data structure is outdated. After the data instance is time stamped, the data receive operation 716 caches the data instance and corresponding time stamp to the local data structure. From the data receive operation 716, the operation flow passes to a create view operation 718.

The create view operation 718 creates a view of the cached data instance and passes this view of the appropriate business object residing in the business object portion 108. As noted in the process of FIG. 6, the business object receives the view of the data instance and the present operation 610 provides the view of the appropriate business object. The view is a reference to the single instance of data, and therefore views relating to particular data may actually share the data. In this way, modifying the data in one view results in other views recognizing the modification. Such recognition may occur relatively immediately following the modification. From the create view operation 718, the operation flow concludes at the terminate operation 720.

Referring back to the first query operation 706, if an instance of the data specified by the received standard identifier is currently cached in the local data structure, the operation flow passes to a second query operation 710. The second query operation 710 determines whether the cached data instance has been stored in the local data storage for a period in time greater than or equal to an allocated expiration period for that data type. The allocated expiration period varies based on the type of data being tested. As noted in the example above, some data types, e.g., address data, have a much shorter expiration period than other data types, e.g., name data. If the cached data instance has been stored in the local data structure for a period in time greater than or equal to the allocated expiration period, the data is considered outdated or “expired” and the operation flow passes to the access operation 708 and then the data receive operation 716, which operate as previously illustrated to refresh the data instance on the local data structure. As such, the new instance of data retrieved by the access operation 708 and time-stamped and cached by the data receive operation 716 replaces the expired instance of data stored on the local data structure. From the data receive operation 716, the operation flow passes to the create view operation 718 and continues as previously described.

Referring back to the second query operation 710, if the cached data instance has not been stored in the local data structure for a period in time greater than or equal to the allocated expiration period, the operation flow passes from the second query operation 710 to the create view operation 718. As noted above, the create view operation 718 creates a view of the cached data instance and passes this view of the appropriate business object residing in the business object portion 108. The business object receives the view of the data instance and the present operation 610 provides the view of the appropriate business object. From the create view operation 718, the operation flow concludes at the terminate operation 720.

Referring now to FIG. 8, a process 800 generally illustrating operations associated with the retrieval of data by the business layer 104 is shown in accordance with another embodiment of the present invention. More specifically, the process 800 is a sequence of operations performed by the data store sub-portion 114 of the data interface portion 110 in response to receiving an instance of data from the data layer 106 pursuant to a request issued by the data client sub-portion 112. For clarity, the process 800 is illustrated as the data store sub-portion 114 manages a single instance of data received from the data layer 106. However, the data store sub-portion 114 may simultaneously and continuously perform the process 800 for any number of data instances received from the data layer 106. With the embodiment of FIG. 2 in mind, the process 800 is performed using a flow of operations beginning with a start operation 802 and concluding with a terminate operation 818.

The start operation 802 is initiated as the data client sub-portion 112 transmits a standard identifier to the data layer 106. In response, the data layer 106 extracts an instance of the data specified by the standard identifier and transmits the instance to the data store sub-portion 114. As such, the start operation 802 is initiated following performance of the access operation 708 of the process 700 shown in FIG. 7. From the start operation 802, the operation flow passes to a receive operation 804.

The receive operation 804 receives the instance of data extracted and sent by the data layer 106 to the data store sub-portion 114. From the receive operation 804, the operation flow passes to a stamp operation 806. The stamp operation 806 time stamps the data instance with a time reference corresponding to a time when the instance is received by the data store sub-portion 114. After the instance is time stamped, the operation flow passes to a cache operation 808. The cache operation 808 caches the data instance and the corresponding time stamp to the local data structure. From the cache operation 808, the operation flow passes to a notify operation 810.

The notify operation 810 notifies the data client sub-portion 112 that the data instance is currently cached in the local data structure. In response to such a notification, the data client sub-portion 112 creates a view of the data instance and forwards the view of the appropriate business object. As noted in the process of FIG. 6, the business object receives the view of the data instance and the present operation 610 provides the view of the appropriate business object. From the create view operation 810, the operation flow passes to a first query operation 812.

The first query operation 812 determines whether the data instance has been cached in the local data structure for a period in time greater than or equal to the allocated expiration period for that data type. If the data instance has not been cached for a period in time greater than or equal to the allocated expiration period for that data type, the operation flow passes to a second query Operation 814. The second query operation 814 determines whether the data client sub-portion 112 is requesting retrieval of the data instance. If the data client sub-portion 112 is not requesting retrieval of the data instance, the operation flow passes back to the first query operation 812. The operation flow thus continues to pass between the first (812) and second (814) query operations until either the time period for the data instance expires or the data client sub-portion 112 requests retrieval the data instance.

Upon detection that the data client sub-portion 112 is requesting retrieval of the data instance, the operation flow passes to the notify operation 810, where the data store sub-portion 114 notifies the data client sub-portion 112 that the requested data instance is currently cached in the local data structure. The operation flow then passes back to the first query operation 812. Once the length in time that the data instance has been cached equals the allocated expiration period, the first query operation 812 branches the operation flow to a refresh operation 816. The refresh operation 816 accesses the data layer 106 to request a new instance of the data therefrom. In response, the new instance is provided to the data store portion 114, wherein the refresh operation 816 receives the new instance and replaces the outdated instance cached to the local data structure with the new instance. After the data instance is refreshed, the operation flow concludes at the terminate operation 818.

It will be clear that the present invention is well adapted to attain the ends and advantages mentioned, as well as those inherent therein. For example, with respect to the embodiment shown in FIG. 3, an off-line data access procedure may be implemented with the present invention wherein the data interface portion 110, and in a more particular embodiment, the data store sub-portion 114, of the business layer 104 automatically records the local data structure to a local disk drive as the application is being terminated. As the client computer 302 is operated off-line, i.e., without a network connection to external databases 306 of the data layer 106, the business layer 104 operates as described above with the exception that the data layer 106 is implemented to retrieve the data from the local disk drive. As such, the business layer 104 is only operable to retrieve data stored on the local disk drive while the client computer 302 is operating off-line. In accordance with an embodiment, the off-line data access procedure also records to the local disk drive specific instances of data pre-selected by the user of the application for automatic download, even if these specific instances of data are not cached to the local data structure at the time the application is terminated. In this embodiment, the user is provided a graphical user interface through which he/she may customize data that the user would like accessible while operating the client computer 302 off-line.

Furthermore, in accordance with another embodiment, various predetermined types of data may not be cached upon retrieval by the business layer 104, but rather forwarded directly to the appropriate business object, which then provides the data to the requesting component on the presentation layer 102. In this embodiment, the data may be provided as actual data transmitted to the requesting component or through a view, in which case, the data is stored as part of the business object until such time that the application program associated with the requesting component is shut down or terminated. These certain types of data include, without limitation, secure and/or sensitive data as well as data that is very frequently or spontaneously updated.

In accordance with yet another embodiment, the business object portion 108 may apply one or more business rules to each request received from a component on the presentation layer 102. The business rules applied to each request by the business object portion 108 relate to processing which is to be performed prior to either the business object forwarding the standard identifier to the data interface portion 110 or a view of cached data to a requesting module on the presentation layer 102. For example, the business rules applied by the business object portion 108 may relate to verification of logon identification that is input to request access to certain secure data on the data layer 104.

Even further, the expiration processes described in FIGS. 7 and 8 may be replaced or supplemented by an expiration process performed on the data layer 104 in accordance with an embodiment of the present invention. In this embodiment, the data layer 104 records a time reference relative to when each instance of data provided to the data interface portion 110 is extracted from the data layer 106. The time reference for each instance provided to the data interface portion 110 is analyzed to determine which instance cached on the local data structure are outdated, or “expired.” Upon the expiration of an instance of specific data, the data layer 104 extracts a new instance of the data and provides the new instance to the data interface portion 110, thereby automatically refreshing the data.

It should be appreciated that numerous other changes and embodiments are contemplated within the scope of the present invention which will readily suggest themselves to those skilled in the art and which are encompassed in the spirit of the invention disclosed and as defined in the appended claims.

What is claimed is:

1. A system for managing transfer of stored data in an information system between data storage and software components of one or more application programs requesting the stored data to perform electronic tasks, the system comprising:
a first software module receiving at least one request for an instance of data issued by a software component and examining the request to determine an identifier for the instance of data; and
a second software module receiving the identifier from the first software module and accessing the data storage to retrieve the instance of data.

2. A system as defined in claim 1, wherein the second software module caches the instance of data to a local data structure such that the instance of data is available for retrieval in response to subsequent requests by one or more software components.

3. A system as defined in claim 2, wherein the second software module time stamps the instance of data with a time reference relative to a point in time when the instance of data is retrieved from the data storage.

4. A system as defined in claim 3, wherein the second software module analyzes the time reference associated with the cached instance of data to determine whether the instance of data has been cached in the local data structure for a period in time greater than or equal to a predetermined expiration period.

5. A system as defined in claim 4, wherein second software module refreshes the instance of data if it is determined that the instance of data has been cached in the local data structure for a period in time greater than or equal to the predetermined expiration period.

6. A system as defined in claim 1, wherein the first software module creates a business object for the request, the business object being associated with the identifier for the instance of data, the business object sending the identifier determined for the instance of data to the second software module.

7. A system as defined in claim 6, wherein the business object receives a view of the instance of data from the second software module in response to sending the identifier to the second software module, the business object providing the view of the instance of data to the software component to effectuate the retrieval of data pursuant to the request.

8. A system as defined in claim 7, wherein the second software module caches the instance of data to a local data structure such that the instance of data is available for retrieval in response to subsequent requests by one or more software components.

9. A system as defined in claim 8, wherein a second software component issues a subsequent request for the instance of data, the subsequent request being received by the first software module and subsequently examined by the first software module to extract the identifier for the instance of data contained in the subsequent request, wherein the first software module transmits the extracted identifier to the second software module.

10. A system as defined in claim 9, wherein the second software module accesses the local data structure in response to receiving the extracted identifier in order to determine whether the instance of data is contained therein.

11. A system as defined in claim 10, wherein the second software module creates the view of the instance of data cached in the local data structure upon a determination that the instance of data is indeed cached therein, the view being passed by the second software module to the first software module.

12. A system as defined in claim 11, wherein the second software module accesses the data storage to retrieve the instance of data if it is determined that the instance of data is not cached in the local data structure.

13. A system as defined in claim 1, wherein the information system is a single computing system.

14. A system as defined in claim 1, wherein the information system is a client-server network.

15. A system as defined in claim 1, wherein the second software module forwards the instance of data to the first software module, the first software module forwarding the instance of data directly to the software component without caching the instance of data to a local storage medium.

16. A system as defined in claim 1, wherein the second software module forwards the instance of data to the first software module, the first software module caching the instance of data, creating a view of the cached instance of data and providing the view of the software module.

17. A pattern for designing a business layer architecture for managing transfer of stored data in an information system between data storage and software components of one or more application programs requesting the stored data to perform electronic tasks, the pattern comprising:
a first portion receiving requests for instances of data issued by one or more software components; and
a second portion accessing the data storage to retrieve the requested instances of data, wherein the second portion caches the requested instances of data to a local data structure such that the requested instances of data are available for retrieval in response to subsequent requests by one or more software components.

18. A pattern as defined in claim 17, wherein the first portion examines each received request to determine an identifier for each of the requested instances of data, the second portion accessing the data storage and retrieving the requested instances based on the identifiers for the received requests.

19. A pattern as defined in claim 17, wherein the second portion time stamps each of the cached instances of data with a time reference relative to a point in time when each instance of data is retrieved from the data storage.

20. A pattern as defined in claim 19, wherein second portion refreshes the first instance of data if it is determined based on a time reference for the first instance of data that the first instance of data has been cached in the local data structure for a period in time greater than or equal to a predetermined expiration period.

21. A pattern as defined in claim 20, wherein the second portion analyzes the time reference to determine whether the first instance of data has been cached in the local data structure for a period in time greater than or equal to the predetermined expiration period in response to the first portion receiving a request for the first instance of data from the one or more software components.

22. A pattern as defined in claim 17, wherein the business layer architecture resides on a client computer and the data storage resides on a database external to the client computer, the database being accessible to the client computer by way of a client-server network.

23. A pattern as defined in claim 22, wherein the second portion records the local data structure to a disk storage located on the client computer such that a user of the client computer may access the requested instances of data after the client computer has been disconnected from the client-server network.

24. A pattern as defined in claim 23, wherein the second portion accesses the database to retrieve pre-selected instances of data in response to the client computer receiving an application termination command, wherein the pre-selected instances of data are stored to the local disk drive prior to the client computer being disconnected from the client-server network.

25. A software model for managing retrieval of stored data in an information system, the model comprising:
a presentation layer comprising software components of one or more application programs, wherein the software components manipulate data to perform electronic tasks;
a data layer comprising data storage media for storing the data manipulated by the presentation layer; and
a business layer managing retrieval of a first instance of data from the data layer in response to a first request by a first software component of the presentation layer, wherein the business layer comprises:
a first portion examining the first request to determine an identifier for the first instance of data; and
a second portion receiving the identifier from the first portion and accessing the data layer to retrieve the first instance of data.

26. A software model as defined in claim 25, wherein the second portion of the business layer caches the first instance of data to a local data structure such that the first instance of data is available for retrieval in response to subsequent requests by one or more software components of the presentation layer.

27. A software model as defined in claim 26, wherein the second portion of the business layer time stamps the first instance of data with a time reference relative to a point in time when the first instance of data is retrieved from the data layer.

28. A software model as defined in claim 27, wherein the second portion analyzes the time reference associated with the cached first instance of data to determine whether the first instance of data has been cached in the local data structure for a period in time greater than or equal to a predetermined expiration period.

29. A software model as defined in claim 28, wherein the second portion refreshes the first instance of data if it is determined that the first instance of data has been cached in the local data structure for a period in time greater than or equal to the predetermined expiration period.

30. A software model as defined in claim 29, wherein the second portion periodically analyzes the time reference to determine whether the first instance of data has been cached in the local data structure for a period in time greater than or equal to the predetermined expiration period.

31. A software model as defined in claim 29, wherein the second portion analyzes the time reference to determine whether the first instance of data has been cached in the local data structure for a period in time greater than or equal to the predetermined expiration period in response to the first portion receiving a subsequent request from a software component of the presentation layer.

32. A software model as defined in claim 25, wherein the second portion comprises a data store sub-portion for caching the first instance of data to a local data structure such that the first instance of data is available for retrieval in response to subsequent requests by one or more software components of the presentation layer.

33. A software model as defined in claim 32, wherein the second portion comprises a data client sub-portion, the data client sub-portion being responsible for receiving the identifier from the first portion and accessing the data layer to retrieve the first instance of data.

34. A software model as defined in claim 33, wherein the data store sub-portion time stamps the first instance of data with a time reference relative to a point in time when the first instance of data is retrieved from the data layer.

35. A software model as defined in claim 34, wherein the data client sub-portion analyzes the time reference associated with the cached first instance of data to determine whether the first instance of data has been cached in the local data structure for a period in time greater than or equal to a predetermined expiration period.

36. A software model as defined in claim 35, wherein the data client sub-portion refreshes the first instance of data if it is determined that the first instance of data has been cached in the local data structure for a period in time greater than or equal to the predetermined expiration period.

37. A software model as defined in claim 36, wherein the data client sub-portion analyzes the time reference to determine whether the first instance of data has been cached in the local data structure for a period in time greater than or equal to the predetermined expiration period in response to the first portion receiving a subsequent request from a software component of the presentation layer.

38. A software model as defined in claim 34, wherein the data store sub-portion analyzes the time reference associated with the cached first instance of data to determine whether the first instance of data has been cached in the local data structure for a period in time greater than or equal to a predetermined expiration period.

39. A software model as defined in claim 38, wherein the data store sub-portion refreshes the first instance of data if it is determined that the first instance of data has been cached in the local data structure for a period in time greater than or equal to the predetermined expiration period.

40. A software model as defined in claim 39, wherein data store sub-portion periodically analyzes the time reference to determine whether the first instance of data has been cached in the local data structure for a period in time greater than or equal to the predetermined expiration period.

41. A software model as defined in claim 25, wherein the first portion creates a business object for the first request, the business object being associated with the identifier for the first instance of data.

42. A software model as defined in claim 41, wherein the business object sends the identifier determined for the first instance of data to the second portion of the business layer.

43. A software model as defined in claim 42, wherein the business object receives a view of the first instance of data from the second portion in response to sending the identifier to the second portion.

44. A software model as defined in claim 43, wherein the business object provides the view of the first instance of data to the first software component to effectuate the retrieval of data pursuant to the first request.

45. A software model as defined in claim 43, wherein the second portion of the business layer caches the first instance of data to a local data structure such that the first instance of data is available for retrieval in response to subsequent requests by one or more software components of the presentation layer.

46. A software model as defined in claim 45, wherein one or more software components of the presentation layer issue a subsequent request for the first instance of data, the subsequent request being received by the first portion of the business layer and subsequently examined by the first portion to extract the identifier for the first instance of data contained in the subsequent request, wherein the first portion transmits the extracted identifier to the second portion of the business layer.

47. A software model as defined in claim 46, wherein the second portion of the business layer accesses the local data structure in response to receiving the extracted identifier in order to determine whether the first instance of data is contained therein.

48. A software model as defined in claim 47, wherein the second portion creates view of the first instance of data cached in the local data structure upon a determination that the first instance of data is indeed cached therein, the view being transmitted by the second portion to the first portion.

49. A software model as defined in claim 48, wherein the second portion accesses the data layer to retrieve the first instance of data if it is determined that the first instance of data is not cached in the local data structure.

50. A software model as defined in claim 25, wherein the information system is a single computing system.

51. A software model as defined in claim 25, wherein the information system is a client-server network.

52. A software model as defined in claim 51, wherein the presentation layer and the business layer are implemented on client computer, the data layer being implemented on a database.

53. A software model as defined in claim 52, wherein the second portion of the business layer caches the first instance of data to a data structure stored in memory on the client computer such that the first instance of data is available for retrieval in response to subsequent requests by one or more software components of the presentation layer.

54. A software model as defined in claim 53, wherein the second portion records the in memory data structure to a disk storage located on the client computer such that a user of the client computer may access the first instance of data after the client computer has been disconnected from the client-server network.

55. A software model as defined in claim 51, wherein the presentation layer and the business layer are implemented on a server computer, the data layer being implemented on a database.

56. A method for governing data transfer in an information system between data storage and software components of one or more application programs requesting data for use in performing electronic tasks, the method comprising:
utilizing an software architectural model to logically define operations for transferring data between the data storage and the requesting software components, the software architectural model having a presentation layer comprising the requesting software components, a data layer comprising the data storage and a business layer serving as a communication liaison between the presentation layer and the data layer, wherein the business layer is divided into a first portion and a second portion; and
managing retrieval of an instance of data requested by a first software component of the presentation layer, wherein the managing act is performed by the first portion and the second portion operating together to retrieve the instance of data for the first software component.

57. A method as defined in claim 56, wherein the managing act comprises:
receiving a request for the instance of data from the first software component, wherein the request includes an identifier associated with the instance of data; and
creating a business object for managing the transfer of the requested data to the first software component, wherein the receiving act and the creating act are performed by the first portion of the business layer.

58. A method as defined in claim 57, wherein the managing act further comprises:
forwarding the identifier to the second portion of the business layer, wherein the forwarding act is performed by the business object.

59. A method as defined in claim 58, wherein the managing act further comprises:
receiving a view of the instance of data from the second portion in response to forwarding the identifier thereto; and
providing the view of the instance of data to the first software component, wherein the receiving act and the providing act are performed by the business object.

60. A method as defined in claim 59, wherein the managing act further comprises:
receiving the identifier forwarded by the forwarding act;
in response to reception of the identifier, accessing a local data structure to determine whether the instance of data associated with the identifier is currently cached therein, wherein the receiving act and the accessing act are performed by the second portion.

61. A method as defined in claim 60, wherein the managing act further comprises:
if the instance of data is determined to be currently cached in the local data structure, creating a view of the cached instance of data; and
forwarding the view of the cached instance of data to the first portion of the business layer, wherein the creating act and the providing act are performed by the second portion.

62. A method as defined in claim 60, wherein the managing act further comprises:
if the instance of data is determined to not be currently cached in the local data structure, accessing the data layer to retrieve the instance of data therefrom; and
caching the instance of data retrieved from the data layer to the local data structure such that the instance of data is available for retrieval in response to subsequent requests by one or more software components, wherein the accessing act and the caching act are performed by the second portion.

63. A method as defined in claim 56, wherein the managing act comprises:
receiving a request for the instance of data from the first software component, wherein the request includes an identifier associated with the instance of data, wherein the receiving act is performed by the first portion; and
forwarding the identifier to the second portion of the business layer, wherein the forwarding act is performed by the first portion;
receiving the identifier forwarded from the first portion, wherein the receiving act is performed by the second portion;
retrieving the instance of data from the data layer based on the received identifier, wherein the retrieving act is performed by the second portion; and
caching the instance of data retrieved from the data layer into a local data structure such that the instance of data is available for retrieval in response to subsequent requests by one or more software components, wherein the caching act is performed by the second portion.

64. A method as defined in claim 63, wherein the managing act further comprises:
creating a view of the cached instance of data, wherein the creating act is performed by the second portion; and
providing the view of the cached instance of data to the first portion.

65. A method as defined in claim 64, wherein the managing act further comprises:
time stamping the instance of data with a time reference relative to a point in time when the instance of data is retrieved from the data layer; and
analyzing the time reference associated with the cached first instance of data to determine whether the first instance of data has been cached in the local data structure for a period in time greater than or equal to a predetermined expiration period, wherein the time stamping act and the analyzing act are performed by the second portion.

66. A method as defined in claim 65, wherein the managing act further comprises:
refreshing the instance of data if it is determined that the instance of data has been cached in the local data structure for a period in time greater than or equal to the predetermined expiration period.

67. A computer program storage medium readable by a computing system and encoding a computer program for governing data transfer in an information system between data storage and software components of one or more application programs requesting data for use in performing electronic tasks, the computer process comprising:
utilizing an software architectural model to logically define operations for transferring data between the data storage and the requesting software components, the software architectural model having a presentation layer comprising the requesting software components, a data layer comprising the data storage and a business layer serving as a communication liaison between the presentation layer and the data layer, wherein the business layer is divided into a first portion and a second portion; and
managing retrieval of an instance of data requested by a first software component of the presentation layer, wherein the managing act is performed by the first portion and the second portion operating together to retrieve the instance of data for the first software component.

68. A computer program storage medium as defined in claim 67, wherein the managing act comprises:
receiving a request for the instance of data from the first software component, wherein the request includes an identifier associated with the instance of data; and
creating a business object for managing the transfer of the requested data to the first software component, wherein the receiving act and the creating act are performed by the first portion of the business layer.

69. A computer program storage medium as defined in claim 68, wherein the managing act further comprises:
forwarding the identifier to the second portion of the business layer, wherein the forwarding act is performed by the business object.

70. A computer program storage medium as defined in claim 69, wherein the managing act further comprises:
receiving a view of the instance of data from the second portion in response to forwarding the identifier thereto; and
providing the view of the instance of data to the first software component, wherein the receiving act and the providing act are performed by the business object.

71. A computer program storage medium as defined in claim 70, wherein the managing act further comprises:
receiving the identifier forwarded by the forwarding act;
in response to reception of the identifier, accessing a local data structure to determine whether the instance of data associated with the identifier is currently cached therein, wherein the receiving act and the accessing act are performed by the second portion.

72. A computer program storage medium as defined in claim 71, wherein the managing act further comprises:
if the instance of data is determined to be currently cached in the local data structure, creating a view of the cached instance of data; and
forwarding the view of the cached instance of data to the first portion of the business layer, wherein the creating act and the providing act are performed by the second portion.

73. A computer program storage medium as defined in claim 71, wherein the managing act further comprises:
if the instance of data is determined to not be currently cached in the local data structure, accessing the data layer to retrieve the instance of data therefrom; and
caching the instance of data retrieved from the data layer to the local data structure such that the instance of data is available for retrieval in response to subsequent requests by one or more software components, wherein the accessing act and the caching act are performed by the second portion.

74. A computer program storage medium as defined in claim 67, wherein the managing act comprises:
receiving a request for the instance of data from the first software component, wherein the request includes an identifier associated with the instance of data, wherein the receiving act is performed by the first portion; and
forwarding the identifier to the second portion of the business layer, wherein the forwarding act is performed by the first portion;
receiving the identifier forwarded from the first portion, wherein the receiving act is performed by the second portion;
retrieving the instance of data from the data layer based on the received identifier, wherein the retrieving act is performed by the second portion; and
caching the instance of data retrieved from the data layer into a local data structure such that the instance of data is available for retrieval in response to subsequent requests by one or more software components, wherein the caching act is performed by the second portion.

75. A computer program storage medium as defined in claim 74, wherein the managing act further comprises:
creating a view of the cached instance of data, wherein the creating act is performed by the second portion; and
providing the view of the cached instance of data to the first portion.

76. A computer program storage medium as defined in claim 75, wherein the managing act further comprises:
time stamping the instance of data with a time reference relative to a point in time when the instance of data is retrieved from the data layer; and
analyzing the time reference associated with the cached first instance of data to determine whether the first instance of data has been cached in the local data structure for a period in time greater than or equal to a predetermined expiration period, wherein the time stamping act and the analyzing act are performed by the second portion.

77. A computer program storage medium as defined in claim 76, wherein the managing act further comprises:
refreshing the instance of data if it is determined that the instance of data has been cached in the local data structure for a period in time greater than or equal to the predetermined expiration period.
